(19) United States
(12) Patent Application Publication
(10) Pub. No.: US 2020/0021495 A1
(43) Pub. Date: Jan. 16, 2020

(54) Universal Rack Architecture Management System

(71) Applicants: Stephen Klenk, Torrance, CA (US); Brendan Paul Getchel, Boaz, AL (US)

(72) Inventors: Stephen Klenk, Torrance, CA (US); Brendan Paul Getchel, Boaz, AL (US)

(21) Appl. No.: 16/031,941

(22) Filed: Jul. 10, 2018

(51) Int. Cl. H04L 12/24; H04Q 1/22

(52) U.S. Cl. CPC H04L 41/14; H04L 41/0686; H04Q 1/032; H04L 41/22; H04Q 1/22

(57) ABSTRACT

A universal rack architecture management system provides a single point of administration and management through use of a novel universal management appliance. The universal management appliance enables communication between it and at least one serial console device. The universal management appliance also allows for remote control of: a server, a storage array module, a multi-interface module, a firewall, an uninterruptable power supply, a power distribution unit, a computer, a serial console device, and other manageable devices. The universal management appliance also manages an IPMI capable server, including iDRAC, iLO IMM, and ILOM. The universal management appliance monitors and receives real-time telemetry. The universal management appliance uses standard network, IPMI, USB, or Serial (DB9) interfaces. The universal management appliance automatically sends real-time predictive and actual failure notifications and alerts. The universal management appliance operates on an independent base operating system. The system consumes minimal amounts of electricity and generates nominal BTU/heat.

### FIELD OF THE INVENTION

The present invention relates generally to a universal rack architecture management system. More so, the present invention relates to a rack architecture management system that provides a single point of administration and management of multiple concurrent devices through use of a compact, efficient universal management appliance that can be controlled remotely to manage, and communicate with a serial console device; and further remote control of: a server, a storage array module, a multi-interface module, a firewall, an uninterruptable power supply, a power distribution unit, a computer, a serial console device, and other manageable devices; and further manages IPMI capable devices, including iDRAC, iLO IMM, and ILOM; through use of a standard network, IPMI, USB, or Serial (DB9) interfaces; and further comprises a portable communication device that is in communication with, and transmits commands to, the universal management appliance for remote control of management functions; and due to the compactness of the universal management appliance, the system consumes minimal amounts of electricity and generates nominal BTU/heat.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, a rack is a standardized rack or enclosure for mounting multiple electronic equipment modules. The rack is effective for stacking servers, telecom, broadcast video, lighting, audio, and scientific lab equipment. It is known that a standard rack configuration is measured in rack-units (RUs). For example, a blade server may have a rack unit measuring 19 inches wide and having a pitch of 1.75 inches in height. A common computer rack form-factor is 42 RU high, which is a factor in limiting the density or number of components directly mountable into a rack. Higher density component systems are desirable since they require less space per rack enclosure and ultimately less space within the building housing the enclosures.

It is known in the art that a computer appliance is a computer with software or firmware that is specifically designed to provide a specific computing resource. The hardware and software are delivered as an integrated product and may even be pre-configured, so as to provide a turn-key solution for a particular application.

Typically, a server is a computer program or a device that provides functionality for other programs or devices, called “clients”. This architecture is called the client-server model, and a single overall computation is distributed across multiple processes or devices. Servers can provide various functionalities, often called “services”, such as sharing data or resources among multiple clients, or performing computation for a client. A single server can serve multiple clients, and a single client can use multiple servers. It is known that servers can operate with Intelligent Platform Management Interface (IPMI).

It is known in the art that IPMI is a set of computer interface specifications for an autonomous computer subsystem that provides management and monitoring capabilities independently of the host system's CPU, firmware (BIOS or UEFI) and operating system. It is also recognized that IPMI defines a set of interfaces used by system administrators for out-of-band management of computer systems and monitoring of their operation. For example, IPMI provides a way to manage a computer that may be powered off or otherwise unresponsive by using a network connection to the hardware rather than to an operating system or login shell.

Of particular concern is the cooling of the rack's components. During operation, the electrical components produce heat, which must be displaced to ensure the proper functioning of its components. In addition to maintaining normative function, various cooling methods, such as liquid or air cooling, are used to either achieve greater processor performance (e.g., overclocking), or to reduce the noise pollution caused by typical cooling methods (e.g., cooling fans and heat sinks). A frequently underestimated problem when designing high-performance computer systems is the discrepancy between the amount of heat a system generates, particularly in high performance and high density enclosures, and the ability of its cooling system to remove the heat uniformly throughout the rack enclosure.

Other proposals have involved rack architecture that manages various components and servers, and firewalls. The problem with these rack devices is that they cannot be managed, monitored, and changed from a single compact device. Also, they cannot be managed remotely from a personal communication device. Even though the above rack architecture meets some of the needs of the market, a universal rack architecture management system that provides a single point of administration and management through use of a compact, efficient universal management appliance that can be controlled remotely to manage, and communicate with at least one serial console device, is still desired.

### SUMMARY

Illustrative embodiments of the disclosure are generally directed to a universal rack architecture management system that provides a single point of administration and management through use of a compact, efficient universal management appliance. The universal management appliance enables communication between it and at least one serial console device. The universal management appliance can be controlled remotely through a portable communication device to manage and communicate with: a server, a storage array module, a multi-interface module, a firewall, an uninterruptable power supply, a power distribution unit, a computer, a serial console device, and other manageable devices. The portable communication device may include a handheld phone or tablet with an applicable software application that allows communication and commands to the universal management appliance for remote control of management functions.

Further, the universal management appliance manages and communicates with an IPMI capable server, including iDRAC, iLO IMM, and ILOM. Further, the universal management appliance is operable to monitor and receive real-time telemetry. The universal management appliance also uses a standard network, IPMI, USB, or Serial (DB9) interfaces. However, the system is brand agnostic, and not brand specific. The system does not require a specific type or brand of component to operate.

Further, the universal management appliance automatically sends real-time predictive and actual failure notifications and alerts. The universal management appliance operates independently, with its own operating system. Due to the compactness of the universal management appliance, the system does not generate large amounts of heat.

In one aspect, the universal rack architecture management system comprises a rack operable to house at least one electrical device. The universal rack architecture management system may also include a server being housed in the rack. The server comprises an intelligent platform management interface (IPMI). The universal rack architecture management system may also include a universal management appliance that is housed in the rack, and provides a central point of management for other components of the system. The universal management appliance is in communication with the server, or at least one serial console device, or both. The universal management appliance provides remote control functionality. Thus, in one non-limiting embodiment, a portable communication device is operable to communicate and transmit commands to the universal management appliance for remote control of management functions.

In some embodiments, the universal management appliance comprises at least one of the following: an operating system; a serial bus; at least one appliance USB port; at least one expansion slot; at least one network interface controller being operatively connected to the Internet; and a Wi-Fi port. The universal management appliance further comprises a power switch; a storage array module; a power supply module comprising a power supply USB port and a power plug, the power supply USB port is operatively connected to the appliance USB port for powering the universal management appliance; a power distribution unit module. The universal rack architecture management system is operable to monitor and receive real-time telemetry.

The universal rack architecture management system also includes a multi-port interface module that is configured to enable communication between at least one of the following components of the system, including: the server, the universal management appliance, the storage array module, and the at least one serial console device. The multi-port interface module also includes a cryptographic network protocol. The cryptographic network protocol is operatively connected to a serial bus of the universal management appliance.

In another aspect, the rack is a rack being 42 rack units (RU) high.

In another aspect, the universal management appliance is 1 RU high.

In another aspect, the universal management appliance is operable to remotely regulate the at least one serial console device.

In another aspect, the universal management appliance enables remote control, desktop sharing, and file transfer between multiple serial console devices with industry standard remote desktop applications and protocols.

In another aspect, the universal management appliance is operable to automatically send real-time predictive and actual failure notifications and alerts to assigned users through email and mobile text.

In another aspect, the universal management appliance is operable to monitor and report enterprise health in real-time.

In another aspect, the universal management appliance comprises at least three interface types, including: RJ45, DB9 Serial, and USB.

In another aspect, the universal management appliance comprises an onboard repository of firmware, BIOS, and software updates for every connected device.

In another aspect, the universal management appliance is operable to integrate with an SNMP-standardized data center.

In another aspect, the network interface controller enables remote control of multiple computers.

In another aspect, the intelligent platform management interface includes at least one of the following: iDRAC, iLO, IMM, and ILOM.

In another aspect, the firewall includes at least one of the following: virtual private network, MAC exclusion, an RSA encryption, an advanced encryption standard, and secure UN+P/W authentication.

In another aspect, the storage array comprises multiple disc drives and a cache memory.

In another aspect, the operating system includes at least one of the following: Microsoft Windows (for example, Windows 10 Enterprise or other Windows operating systems) or Linux (for example, CentOS, Ubuntu, or other Linux operating systems).

In another aspect, the universal management appliance comprises a web browser.

In another aspect, the web browser includes at least one of the following: Chrome and Firefox.

One objective of the present invention is to monitor and manage an entire enterprise remotely anytime, anywhere through use of a compact, scalable universal management appliance.

Another objective is to simultaneously manage every server, storage array, switch, firewall, UPS, PDU, desktop, laptop, workstation, and other manageable device in the enterprise.

Another objective is to enable remote console level access.

Another objective is to efficiently displace heat from the universal management appliance, the at least one serial console device, the power supply module, the power distribution module, and the multi-port interface module.

Yet another objective is to reduce the cost and complexity of managing the enterprise because it allows direct management of all rack equipment from a smartphone, tablet, laptop or other device, anytime and anywhere.

Yet another objective is to manage switches via SSH, UPS devices via USB, and even client side network devices, such as desktops, workstations, laptops, printers and scanners.

Yet another objective is to provide a universal management appliance that operates independently of all installed client Operating Systems (Windows, Linux, Unix, Mac, etc.) and network types or topologies (GbE, Copper, Fiber, NAS, SAN, etc).

Yet another objective is to provide a Plug and Play solution to bring all IPMI compliant devices iDRAC, iLO, IMM, and ILOM into the simplicity of a Single Point of Administration and Management.

Yet another objective is to provide a universal management appliance that is 1 RU high, for installation in any standard server, network or telco rack cabinet.

Yet another objective is to provide a universal rack architecture management system with ultralow power consumption of just 132 W under load, and low heat output of less than 450 BTU, so that the universal management appliance has no appreciable impact on power and cooling load in most data centers.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a front view of an exemplary universal rack architecture management system, in accordance with an embodiment of the present invention; and

FIG. 2 illustrates a diagram of manageable devices for the universal rack architecture management system, in accordance with an embodiment of the present invention.

Like reference numerals refer to like parts throughout the various views of the drawings.

### DETAILED DESCRIPTION OF THE INVENTION

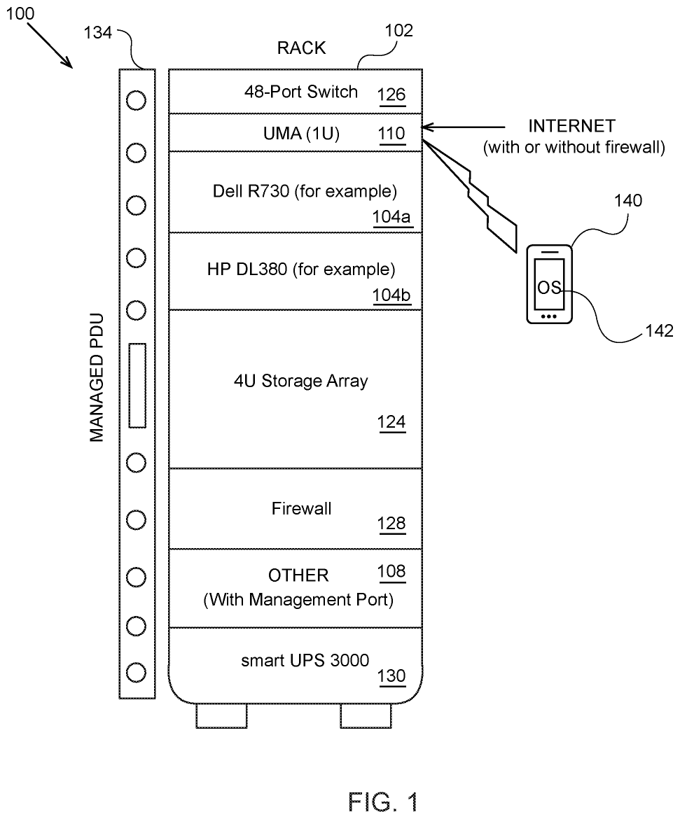

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

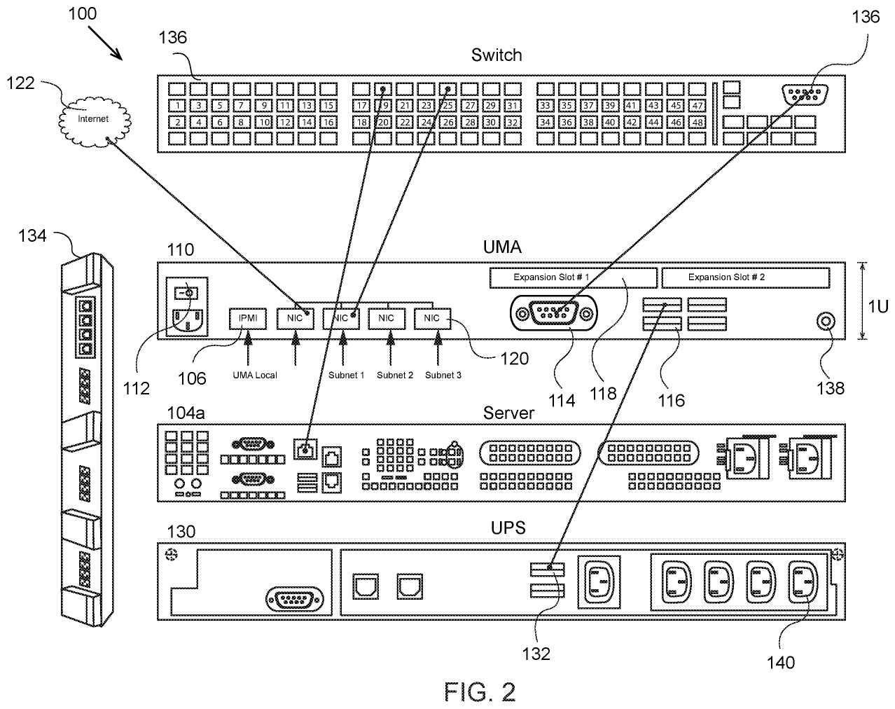

A universal rack architecture management system 100 is referenced in FIGS. 1-2. The universal rack architecture management system 100, hereafter “system 100” provides a centralized means to manage and monitor an entire enterprise in a rack, remotely, from a personal communication device 140. The system 100 provides a unique compact universal management appliance 110 that combines hardware and software features to provide a single point of administration and management that encompasses all rack equipment, including, server 104a, 104b, storage arrays module 124, networking, power units 132, 134, and other serial console devices 108 through use of a standard network/IPMI, USB or Serial (DB9) interface.

As FIG. 1 references, system 100 includes a universal management appliance 110 that enables communication between at least one serial console device 108. The universal management appliance 110 can be controlled remotely through a portable communication device to manage and communicate with: at least one server 104a, 104b, a storage array module 124, a multi-interface module 126, a firewall 128, and at least one serial console device 108. In this manner, installing firmware updates, power cycling equipment, and making system changes at the firmware level are facilitated, and can be performed remotely from the hardware.

As illustrated in FIG. 2, the system 100 comprises a rack 102 operable to house at least one electrical device. The rack 102 may include an enterprise rack used for stacking serial console devices 108 and other components discussed below. In one non-limiting embodiment, the rack 102 contains multiple mounting slots or bays, each designed to hold a hardware unit secured in place with screws. Those skilled in the art will recognize that a rack server has a low-profile enclosure, in contrast to a tower server, which is built into an upright, standalone cabinet. Thus, the rack 102 may be either, and may also measure the standard 42 rack units (RU) high. Though in other embodiments, other dimensions may be used.

The system 100 may also include at least one server 104a, 104b that is housed in the rack 102. In one non-limiting embodiment, the at least one server 104a comprises a simple mail transfer protocol Internet standard. The simple main transfer is included in the universal management appliance 110, and is optionally enabled. The server 104a-b comprises an intelligent platform management interface 106 (IPMI). In some embodiments, the server 104a-b may include, without limitation, Dell, EMC, HP, IBM, Quantum, and other server 104a-b providers known in the art. In one embodiment, the IPMI 106 includes at least one of the following: iDRAC, iLO, IMM, and ILOM. Though in other embodiments, different types of servers and IPMI 106 may be used.

The universal rack architecture management system 100 may also include a universal management appliance 110 that is housed in the rack 102, and provides a central point of management for other components of the system 100. The universal management appliance 110 is compact, so as not to generate large amounts of heat. This helps in dispersing heat from the rack 102. In one non-limiting embodiment, the universal management appliance 110 is 1 RU high.

In some embodiments, the universal management appliance 110 may be in operational communication with the server 104a, 104b, or at least one serial console device 108, or both the server 104a-b and the serial console device 108. Switches, described below provide a connective point of reference for this communication. The universal management appliance 110 can simultaneously manage any device with a connected management port. In some embodiments, the universal management appliance 110 may be configured to manage serial console devices 108 from technology manufacturers, such as, Dell, HP, IBM, Supermicro, Cisco, APC, and others known in the art. Further, the universal management appliance 110 comprises at least three interfaces. Three possible interfaces may include, without limitation, RJ45, DB9 Serial, and USB, though in other embodiments, similar interfaces and technologies may be used.

The universal management appliance 110 provides remote control functionality. Thus, in one non-limiting embodiment, a portable communication device is operable to communicate and transmit commands to the universal management appliance 110 for remote control of management functions. Thus, the universal management appliance 110 is operable to remotely regulate the at least one serial console device 108 and/or the server 104a-b. In some embodiments, the universal management appliance 110 enables a robust remote control capacity for functions such as: desktop sharing, remote monitoring, and file transfer between multiple serial console devices 108. Software such as TeamViewer and WebX may be used for this capability.

Looking again at FIG. 1, the universal management appliance 110 comprises a few known hardware components. These may include, at least one appliance USB port 116, and at least one expansion slot 118. The USB port 116 may include a standard cable connection interface for communicating with at least one serial console device 108, personal computers, and consumer electronics devices. The expansion slot 118 provides a space for an expansion card to be fitted, so as to expand memory.

The universal management appliance 110 further comprises an operating system 142. The operating system 142 is independent of external operating systems, and includes, without limitation, at least one of the following operating systems: Microsoft Windows (for example, Windows 10 Enterprise or other Windows operating systems) or Linux (for example, CentOS, Ubuntu, or other Linux operating systems). In addition to the base operating system, a web browser may also be part of the system 100. Exemplary web browsers may include Chrome and Firefox.

In addition to an independent operating system 142, the system 100 exhibits more independence by not requiring third party hardware. This is possible, as the universal management appliance 110 seamlessly integrates with all existing network hardware and topologies. However in other embodiments, the universal management appliance 110 manages serial console devices 108 using a web browser, Java, or any proprietary device management application that can be installed in a Linux (or Windows) environment. In this manner, the system 100 drastically lowers Total Cost of Ownership by employing simplified licensing regardless of the scale of the enterprise.

In some embodiments, the firewall 128 is managed, monitored, and configurable through the universal management appliance 110. In some embodiments, the firewall 128 may include at least one of the following: virtual private network, MAC exclusion, an RSA encryption, an advanced encryption standard, and secure UN+P/W authentication. Additional security features provided by the universal management appliance 110, may include closing security holes by eliminating the requirement for individual devices to be connected to the Internet 122. This eliminates many points of potential vulnerability while introducing multilayer hard and soft security measures.

Continuing with FIG. 2, the system 100 also provides, a computer, a serial console device 108, and other manageable devices that can be managed and monitored by the universal management appliance 110. The portable communication device 140 may include an NCI laptop computer, a handheld phone, or a tablet having an applicable software application that allows communication and commands to the universal management appliance 110 for remote control of management functions.

In some embodiments, the universal management appliance 110 is specially configured to manage, monitor, and communicate with an intelligent platform management interface 106 (IPMI) capable server 104a-b. A server having the IPMI capabilities may include, without limitation, iDRAC, iLO, IMM, and ILOM.

Further, the universal management appliance 110 is operable to monitor and receive real-time telemetry, creating an automated communications process by which measurements and other data are collected at remote or inaccessible points and transmitted to receiving equipment for monitoring. In one exemplary use of the telemetry function, data is gathered on the use of the server 104a, 104b and the serial console devices 108, e.g. how often certain features are used, measurements of start-up time and processing time, hardware, application crashes, and general usage statistics.

In yet other embodiments, the universal management appliance 110 uses standard network, IPMI, USB, or Serial (DB9) interfaces, though other similar interface technologies may also be used. Further, the universal management appliance 110 automatically sends real-time predictive and actual failure notifications and alerts. These alerts can be transmitted to a registered user for monitoring the rack equipment. The universal management appliance 110 operates independently, with its own base operating system 142. Thus, external operating systems are not necessary.

In yet another unique feature, the compactness of the universal management appliance 110 provides the benefit that the system 100 does not generate large amounts of heat; and thereby efficiently displaces heat from the rack and equipment. The universal management appliance 110 requires only a single rack unit (1 RU), consumes very little power (less than 140 watts), and generates very little heat while providing huge ROI by condensing hardware management into a single, simple, diminutive package. With virtually no impact on the enterprise carbon footprint, managing the data center is facilitated and “green”, helping users comply with environmental computing initiatives, and reducing the carbon footprint.

Looking again at FIG. 1, the system 100 comprises multiple power consumption and distribution features for the enterprise. Thus, in one embodiment, an uninterruptable power supply 130 (UPS) and a power distribution unit 134 (PDU) are managed and monitored by the universal management appliance 110. The UPS 130 is comprised of a power supply USB port 132 and a power plug. The power supply USB port 132 is operatively connected to the appliance USB port 116 for powering the universal management appliance 110. The PDU 134 is fitted with multiple outputs designed to distribute electric power to the serial console devices 108 in the rack 102. Those skilled in the art will recognize that PDU 134 monitoring improves efficiency, uptime, and growth.

In some embodiments, the system 100 also may also provide at least one network interface controller 120 (NIC) that is operatively connected to the Internet 122. The NIC 120 enables remote control of multiple computers. This is a necessity for the remote control capacity of the system 100. Additionally, a Wi-Fi port 138 may be used by the universal management appliance 110 for Internet 122 connectivity. The universal management appliance 110 further comprises a power switch 112 and a storage array module 124. The storage array module 124 may include multiple disc drives and a cache memory.

In some embodiments, the universal management appliance 110 comprises an onboard repository of firmware, BIOS, and software updates for every connected serial console device 108. The onboard repository is configured to log and report which serial console devices 108 and server 104a, 104bs have been updated, and which devices need to be updated. The universal management appliance 110 is configured to log update results so the user can track and report issues associated with certain updates that might introduce update related problems or “breaks” in other functionalities. This can be displayed on the portable communication device in a color coded report. For example, reported update statuses are BLUE “optional”; GREEN “recommended”; YELLOW “important”; and RED “urgent”.

In some embodiments, the universal management appliance 110 is operable to integrate with an SNMP-standardized data center. This is accomplished with seamless integration. In additional embodiments, the universal management appliance 110 is operable to automatically send real-time predictive and actual failure notifications and alerts to assigned users through email and mobile text. The universal rack architecture management can connect to any email server 104a, 104b (SMTP/IMAP, etc.), or can use a built in dedicated SMTP Server 104a, 104b, to send instant alerts as problems arise. In this function, the universal management appliance 110 schedules automated routine maintenance tasks (CHRONJOBs, etc.).

In another unique feature, the universal management appliance 110 is operable to monitor and report enterprise health in real-time. The universal management appliance 110 continuously monitors and reports enterprise health at a glance in real-time. The universal management appliance's 110 searchable Historical Logging and Tracking System 100 (HLTS) maintains infinite historical “health” records for all managed devices.

The HLTS detects patterns, predicts failures, and allows the user to proactively make changes before failures actually occur. Those skilled in the art will recognize that this is different than typical reactionary UT environments which wait for and respond to failures after they actually occur. The universal management appliance's 110 HLTS data can be used by Artificial Intelligence and Machine Learning engines to further enhance predictive abilities, enabling optimal proactive management of the enterprise. In this capacity, the universal management appliance 110 can assign a dedicated internal NAS Share to store Updates and LOG Files for access by other users or enterprise monitoring tools.

The universal rack architecture management system 100 also includes a multi-port interface module 126 that is configured to enable communication between at least one of the following components of the system 100, including: the server 104a-b, the universal management appliance 110, the storage array module 124, and the at least one serial console device 108. The multi-port interface module 126 also includes a cryptographic network protocol 136. The cryptographic network protocol 136 is operatively connected to a serial bus on the universal management appliance 110.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A universal rack architecture management system, the system comprising:
a rack;
at least one server being housed in the rack, the server having an intelligent platform management interface;
a universal management appliance being housed in the rack, the universal management appliance being in communication with the server, or at least one serial console device, or both, the universal management appliance further being operable to monitor and receive real-time telemetry, the universal management appliance comprising at least one of the following:
an operating system,
at least one appliance USB port,
at least one expansion slot,
at least one network interface controller, and
a power switch;
a storage array module;
a power supply module comprising a power supply USB port, the power supply USB port being operatively connected to the appliance USB port for powering the universal management appliance; and
a multi-port interface module configured to enable communication between at least one of the following: the server, the universal management appliance, the storage array module, the at least one serial console device, and the at least one network interface controller,
the multi-port interface module comprising a cryptographic network protocol.

2. The system of claim 1, further comprising a power distribution unit module.

3. The system of claim 1, wherein the at least one server comprises a simple mail transfer protocol Internet standard.

4. The system of claim 1, wherein the universal management appliance is 1 rack unit high.

5. The system of claim 1, wherein the universal management appliance is operable to remotely regulate the at least one serial console device.

6. The system of claim 1, wherein the universal management appliance enables remote control, desktop sharing, remote monitoring, and file transfer between the at least one serial console device.

7. The system of claim 1, wherein the universal management appliance is operable to automatically send real-time predictive and actual failure notifications and alerts through email and mobile text.

8. The system of claim 1, wherein the universal management appliance is operable to monitor and report enterprise health in real-time.

9. The system of claim 1, wherein the universal management appliance is comprised of at least three interface types, including at least one of the following: RJ45, DB9 Serial, and USB.

10. The system of claim 9, wherein the universal management appliance comprises a Wi-Fi port.

11. The system of claim 1, wherein the universal management appliance comprises an onboard repository of firmware, BIOS, and software updates for every connected device.

12. The system of claim 1, wherein the universal management appliance is operable to integrate with an SNMP-standardized data center.

13. The system of claim 1, wherein the intelligent platform management interface includes at least one of the following: iDRAC, iLO, IMM, and ILOM.

14. The system of claim 1, further comprising a firewall, the firewall including at least one of the following: virtual private network, MAC exclusion, an RSA encryption, an advanced encryption standard, and secure U/N+P/W authentication.

15. The system of claim 1, further comprising a portable communication device in communication with the universal management appliance.

16. The system of claim 1, wherein the cryptographic network protocol comprises a Secure Shell.

17. The system of claim 1, wherein the operating system includes at least one of the following operating systems: Microsoft Windows (for example, Windows 10 Enterprise or other Windows operating systems) or Linux (for example, CentOS, Ubuntu, or other Linux operating systems).

18. The system of claim 1, wherein the universal management appliance comprises a web browser.

19. The system of claim 1, wherein the at least one network interface controller is operatively connected to the Internet.

20. A universal rack architecture management system, the system consisting of:
a rack, the rack operable to house at least one serial console device;
at least one server being housed in the rack, the server having an intelligent platform management interface, the intelligent platform management interface including at least one of the following: iDRAC, iLO, IMM, and ILOM;
a universal management appliance being in communication with the server, the at least one serial console device, or both, the universal management appliance further being operable to monitor and receive real-time telemetry, the universal management appliance enabling remote control, desktop sharing, remote monitoring, and file transfer between the at least one serial console device with remote desktop control software, the universal management appliance being operable to automatically send real-time predictive and actual failure notifications and alerts through email and mobile text, the universal management appliance being operable to integrate with an SNMP-standardized data center,
the universal management appliance comprising at least one of the following:
an operating system,
at least one appliance USB port,
at least one expansion slot,
at least one network interface controller being operatively connected to the Internet,
a web browser, the web browser including at least one of the following: Chrome and Firefox,
a Wi-Fi port, and
a power switch;
a storage array module, the storage array module comprising multiple disc drives and a cache memory;
a firewall, the firewall including at least one of the following: virtual private network, MAC exclusion, an RSA encryption, an advanced encryption standard, and secure U/N+P/W authentication;
a power supply module comprising a power supply USB port and a power plug, the power supply USB port being operatively connected to the appliance USB port for powering the universal management appliance;
a power distribution unit module supported by the rack;
a multi-port interface module configured to enable communication between at least one of the following: the server, the universal management appliance, the storage array module, the at least one serial console device, and the at least one network interface controller,
the multi-port interface module comprising a cryptographic network protocol for operating network services securely over an unsecured network; and
a portable communication device being in communication with the universal management appliance.
